(19) United States
(12) Patent Application Publication
(10) Pub. No.: US 2007/0274178 A1
(43) Pub. Date: Nov. 29, 2007

(54) Information Recording Medium, Information Recording Device And Method, Information Reproducing Device And Method, And Computer Program

(76) Inventor: Kazuo Kuroda, Saitama (JP)

Correspondence Address: YOUNG & THOMPSON, 745 SOUTH 23RD STREET, 2ND FLOOR, ARLINGTON, VA, 22202, US

(21) Appl. No.: 10/592,359

(22) PCT Filed: Mar. 9, 2005
(86) PCT No.: PCT/JP05/04132

§ 371 Date: Oct. 17, 2006

(30) Foreign Application Priority Data
Mar. 12, 2004 (JP) 2004-070488

(51) Int. Cl. G11B 15/00

(52) U.S. Cl. 369/47.4; 369/47.44

(57) ABSTRACT

An information recording medium (100) which is rotationally driven at a rotational speed in a range set in advance, provided with allowance information recorded on said information recording medium, the allowance information indicating a range of an allowable rotational speed.

### TECHNICAL FIELD

The present invention relates to an information recording medium, such as a DVD, for example, an information recording apparatus, such as a DVD recorder, for example, an information recording method, an information reproducing apparatus, such as a DVD player, an information reproducing method, and a computer program which makes a computer function as the information recording apparatus or the information reproducing apparatus.

### BACKGROUND ART

Optical discs, such as a CD (Compact Disc) and a DVD, are generalized. With regard to these optical discs, information is recorded onto the optical disc, or the recorded information is read, by laser irradiated from an optical pickup. Then, the recording operation and the reproduction operation are performed by displacing the optical pickup along a track formed spirally on the optical disc, for example. Moreover, the laser irradiated from the optical pickup is focused on an information pit formed on the track. By this, information content indicated by the information pit is read.

Moreover, a recording speed for recording the data onto the optical disc, or a reproduction speed for reproducing the data, has increased along with the advancement of technology. For example, a recording speed or reproduction speed of 2-time speed, 4-time speed, 8-time speed, and the like has been realized, by increasing the rotational speed of the optical disc in accordance with the standard (or specifications) of the optical disc, or by adjusting the irradiation pattern of the laser, as occasion demands.

### DISCLOSURE OF INVENTION

### Subject to be Solved by the Invention

On the other hand, even by increasing the rotational speed of the optical disc in this manner, there is a limit on the rotational speed, depending on the features relating to the structure of the optical disc, or the performance or the like of a spindle motor or the like for rotating the optical disc. Therefore, depending on the optical disc which is a target of information recording or information reproduction, there is an optical disc which cannot realize a rotational speed of over 10000 rpm (revolution per minute), which is required to realize a recording speed of a 16-time speed, for example. Moreover, depending on the optical disc, if the information is recorded or reproduced except in a partial recording area of the optical disc, there is also an optical disc which cannot realize a rotational speed of over 10000 rpm except in a partial recording area of the optical disc.

In such a case, it is hardly possible to recognize whether the optical disc can be rotated over 10000 rpm, on an information recording apparatus for recording the data and/or a reproducing apparatus for reproducing the data. Even if a high recording speed or the like is allowed, theoretically, or in terms of the level of technology, there is such a technical problem that the high recording speed or the like cannot be stably realized in actual productions.

In order to solve the above-mentioned conventional problem, it is therefore an object of the present invention to provide an information recording medium, an information recording apparatus, an information recording method, an information reproducing apparatus, and an information reproducing method, which enable the rotational speed of the information recording medium to be properly controlled, for example, and a computer program which makes a computer function as such an information recording apparatus or an information reproducing apparatus.

### Means for Solving the Subject

(Information Recording Apparatus)

The above object of the present invention can be achieved by an information recording medium which is rotationally driven at a rotational speed in a range set in advance, the information recording medium provided with allowance information recorded on the information recording medium, the allowance information indicating a range of an allowable rotational speed.

According to the information recording medium of the present invention, the information recording medium is rotationally driven at the rotational speed in a range set in advance, with the rotational speed fixed or changed, for example.

Particularly in the present invention, the allowance information is recorded on the information recording medium. The allowance information indicates the range of the allowable rotational speed. Namely, the allowance information indicates the range of the rotational speed in which the information recording medium can be actually rotationally driven.

Therefore, an information recording apparatus or an information reproducing apparatus described later can preferably rotationally drive the information recording medium, by referring to the allowance information. For example, it is possible to effectively prevent such a disadvantage that the information recording medium is rotationally driven at the rotational speed which cannot be used (or which must not be used) for the rotation driving. In particular, it is effectively prevent such a situation that the information recording medium is rotationally driven at a smaller rotational speed although the information recording medium can be rotationally driven at a larger recording speed in fact, due to a restriction or the like in the standard of the information recording medium, for example. Therefore, the information recording apparatus or the like can rotationally drive the information recording medium at the larger rotational speed (or at the rotational speed as large as possible), and along with that, it can record the record information at a relatively high recording speed, or it can reproduce the record information at a relatively high reproduction speed.

Incidentally, with regard to the information recording medium currently distributed in the market, information such as the allowance information indicating the range of the allowable rotational speed is not recorded thereon, different from in the information recording medium of the present invention. Therefore, the information recording medium is rotationally driven in accordance with the restriction or the like in the standard of the information recording medium, for example. Thus, if following (or confirming) the current standard of the information recording medium, although it can be rotationally driven at a larger recording speed in fact, the information recording medium can be rotationally driven at a smaller rotational speed according to the restriction or the like in the standard. If so, it is impossible to realize the relatively high recording speed or reproduction speed. However, the information recording medium of the present invention hardly has or does not have such a problem at all because the allowance information is recorded thereon, so that there is such a great advantage that the relatively high recording speed or reproduction speed can be realized.

Consequently, according to the information recording medium of the present invention, it is possible to preferably control the rotational speed of the information recording medium due to the allowance information. Along with that, it is possible to realize the relatively high recording speed or reproduction speed.

In one aspect of the information recording medium of the present invention, the allowance information is recorded with address information indicating a position of a recording area in which record information is recorded.

According to this aspect, in obtaining the address information referred to in a normal recording operation or the like, the allowance information can be obtained together. Therefore, without giving a great influence to the normal recording operation or the like, or with adapting the progress of the normal recording operation or the like, it is possible to properly control the rotational speed of the information recording medium.

In another aspect of the information recording medium of the present invention, the information recording medium is rotationally driven such that the rotational speed is changed in accordance with at least a radial position.

According to this aspect, even in the case of the information recording medium which is rotationally driven such that the rotational speed is changed in accordance with the radial position (e.g. information recording media related to a CLV recording method, a ZCLV recording method, and a ZCAV recording method described later), it can be preferably rotationally driven, on the basis of the allowance information. Namely, on the basis of the allowance information, the information recording medium is rotationally driven such that the rotational speed is preferably changed in accordance with the radial position, for example.

In an aspect of the information recording medium in which the rotational speed is changed in accordance with the radial position, as described above, the allowance information indicates a plurality of ranges of a the allowable rotational speed in accordance with the radial position.

By virtue of such construction, it is possible to preferably control the rotational speed of the information recording medium, on the basis of the allowance information, even in the case of the information recording medium whose rotational speed is changed in accordance with the radial position

In an aspect of the information recording medium in which the rotational speed is changed in accordance with the radial position, as described above, the allowance information are recorded by at least one, with respect to each of radial positions in each of which the rotational speed is changed.

By virtue of such construction, it is possible to preferably control the rotational speed of the information recording medium, in response to the changing of rotational speed, on the basis of the allowance information, even in the case of the information recording medium whose rotational speed is changed in accordance with the radial position.

In another aspect of the information recording medium of the present invention, the allowance information includes flag information indicating whether or not the allowable rotational speed is equal to or greater than a predetermined rotational speed.

According to this aspect, it is possible to control the rotational speed of the information recording medium, relatively easily, by referring to the flag information.

In another aspect of the information recording medium of the present invention, the allowance information indicates a range of at least one of an allowable recording speed which can be allowed when record information is recorded, and an allowable reproduction speed which can be allowed when the record information is reproduced, in addition to or instead of indicating the allowable rotational speed.

According to this aspect, it is possible to properly control the recording speed and the reproduction speed, on the basis of the allowance information.

In an aspect of the information recording medium in which the allowance information indicates the range of the allowable recording speed, as described above, at least one of the recording speed and the reproduction speed is changed in accordance with at least the radial position, on the information recording medium, and the allowance information indicates at least one of the allowable recording speed and the allowable reproduction speed in accordance with the radial position.

By virtue of such construction, even in the case of the information recording medium in which the recording speed or the reproduction speed is changed in accordance with the radial position, it is possible to preferably control the recording speed and the reproduction speed, on the basis of the allowance information. Namely, inevitably, it is possible to preferably control the rotational speed of the information recording medium.

In another aspect of the information recording medium of the present invention, the allowance information can be rewritten.

According to this aspect, as needed, the allowance information can be rewritten, as occasion demands, so that it is possible to further improve the reliability of the allowance information. Therefore, on the basis of the allowance information whose reliability is improved, it is possible to preferably control the rotational speed of the information recording medium.

(Information Recording Apparatus)

The above object of the present invention can be also achieved by an information recording apparatus provided with: a first recording device for recording record information onto the above-mentioned information recording medium of the present invention (including its various aspects); a rotation driving device for rotationally driving the information recording medium; a reading device for reading the allowance information; and a first controlling device for controlling the rotation driving device, on the basis of the read allowance information.

According to the information recording apparatus of the present invention, the record information including content data or the like can be recorded onto the information recording medium, by the operation of the first recording device. Moreover, the rotational speed of the information recording medium can be controlled by the operation of the rotation driving device. Namely, it is possible to arbitrarily change the rotational speed of the information recording medium.

Particularly in the present invention, the allowance information recorded on the information recording medium can be read by the operation of the reading device. Then, the rotation driving device is controlled by the operation of the first controlling device, on the basis of the allowance information read by the reading device. Namely, the rotational speed of the information recording medium is controlled, on the basis of the allowance information. Specifically, it is possible to preferably rotationally drive the information recording medium, in the range of the allowable rotational speed indicated by the allowance information.

Thus, as described above, for example, the information recording medium can be rotationally driven at the larger rotational speed (or at the rotational speed as large as possible), and along with that, it is possible to record the record information at the relatively high recording speed, or it is possible to reproduce the record information at the relatively high reproduction speed.

Consequently, according to the information recording apparatus of the present invention, it is possible to preferably control the rotational speed of the information recording medium, on the basis of the allowance information. Along with that, it is possible to properly realize the relatively high recording speed or the like.

In one aspect of the information recording apparatus of the present invention, the information recording apparatus is further provided with a detecting device for detecting a crack of the information recording medium, and the first controlling device controls the rotational speed on the basis of the allowance information if the crack is not detected, and controls the rotational speed so as to be a predetermined rotational speed if the crack is detected.

According to this aspect, it is possible to control the rotational speed of the information recording medium, depending on whether the crack is detected or not. Namely, if the crack is not detected, the state of the information recording medium is normal, so that it is possible to preferably control the rotational speed of the information recording medium, on the basis of the allowance information. On the other hand, if the crack is detected, it cannot be said that the state of the information recording medium is normal, so that it is possible to control the rotational speed of the information recording medium so as to be the predetermined rotational speed (more preferably, a rotational speed at which the record information can be stably recorded or reproduced even if there is the crack), without being based on the allowance information. Therefore, whether the crack is detected or not, in either case, it is possible to preferably control the rotational speed of the information recording medium.

In an aspect of the information recording apparatus provided with the detecting device, as described above, the detecting device detects the crack by detecting at least one of vibration and sound of the information recording medium.

By virtue of such construction, if the crack is generated, as compared to the case where the crack is not generated, the vibration (i.e. noise-like vibration) in rotating the information recording medium increases, or an abnormal sound is generated, so that it is possible to properly detect the presence or absence of the crack (or its extent).

In an aspect of the information recording apparatus provided with the detecting device, as described above, the detecting device detects the crack by detecting an error rate of the record information to be recorded onto the information recording medium.

By virtue of such construction, if the crack is generated, as compared to the case where the crack is not generated, the error rate of the record information deteriorates, so that it is possible to properly detect the presence or absence of the crack (or its extent).

In an aspect of the information recording apparatus provided with the detecting device, as described above, the detecting device detects the crack by detecting whether or not the record information to be recorded onto the information recording medium can be reproduced.

By virtue of such construction, if the crack is generated, as compared to the case where the crack is not generated, it is difficult or impossible to reproduce the record information, so that it is possible to properly detect the presence or absence of the crack (or its extent).

In another aspect of the information recording apparatus of the present invention, it is further provided with a second recording device for recording the allowance information onto the information recording medium.

According to this aspect, as needed, the allowance information can be rewritten or additionally recorded (or written once), as occasion demands, so that it is possible to further improve the reliability of the allowance information. Therefore, if the allowable rotational speed indicated by the allowance information can be changed, it is possible to update the allowance information, as occasion demands.

In an aspect of the information recording apparatus provided with the second recording device, as described above, the information recording apparatus further comprises a determining device for determining a range of the allowable rotational speed in accordance with presence of at least one of a crack of the information recording medium and an eccentricity having an amount more than a predetermined amount, and the second recording device records at least one of the allowance information indicating the range of the allowable rotational speed determined by the determining device, and flag information indicating at least one of the crack and the eccentricity having the amount more than the predetermined amount.

By virtue of such construction, it is possible to rewrite the allowance information, as occasion demands, in accordance with the presence of the crack or the eccentricity having more than the predetermined amount. Therefore, regardless of a change over time generated on the optical disc and variations in manufacturing, the preferable allowance information can be maintained, and as a result, it is possible to properly control the rotational speed of the information recording medium.

In another aspect of the information recording apparatus of the present invention, it is for recording the record information onto the information recording medium on which the allowance information indicating the range of the allowable recording speed is recorded, and it is further provided with: a second controlling device for controlling the recording speed when the first recording device records the record information.

According to this aspect, it is possible to properly control the recording speed, on the basis of the allowance information.

(Information Recording Method)

The above object of the present invention can be also achieved by an information recording method in an information recording apparatus for recording record information onto the above-mentioned information recording medium of the present invention (including its various aspects), the information recording method provided with: a reading process of reading the rotational speed information; and a rotation driving process of rotationally driving the information recording medium on the basis of the read rotational speed information.

According to the information recording method of the present invention, it is possible to receive the same benefits as those of the information recording apparatus of the present invention.

Incidentally, in response to the above-mentioned various aspects of the information recording apparatus of the present invention, the information recording method of the present invention can also adopt various aspects.

(Information Reproducing Apparatus)

The above object of the present invention can be also achieved by an information reproducing apparatus provided with: a reproducing device for reproducing record information recorded on the above-mentioned information recording medium of the present invention (including its various aspects); a rotation driving device for rotationally driving the information recording medium; a reading device for reading the allowance information; and a first controlling device for controlling the rotation driving device, on the basis of the read allowance information.

According to the information reproducing apparatus of the present invention, as in the above-mentioned information recording apparatus of the present invention, the rotational speed of the information recording medium can be properly controlled by the operation of the controlling device, on the basis of the allowance information read by the reading device. Therefore, it is possible to preferably reproduce the record information while properly controlling the rotational speed of the information recording medium. Namely, it is possible to receive the same various benefits as those of the information recording apparatus of the present invention.

Incidentally, in response to the above-mentioned various aspects of the information recording medium of the present invention, the information reproducing apparatus of the present invention can also adopt various aspects.

Incidentally, in response to the above-mentioned various aspects of the information recording apparatus of the present invention, the information reproducing apparatus of the present invention can also adopt various aspects.

The information reproducing apparatus of the present invention is for reproducing the record information recorded on the information recording medium on which the allowance information indicating the range of the allowable reproduction speed, and it is further provided with: a second controlling device for controlling the reproduction speed when the reproducing device reproduces the record information.

According to this aspect, it is possible to properly control the reproduction speed, on the basis of the allowance information.

(Information Reproducing Method)

The above object of the present invention can be also achieved by an information reproducing method in an information reproducing apparatus for reproducing record information recorded on the above-mentioned information recording medium of the present invention including its various aspects), the information reproducing method provided with: a reading process of reading the allowance information; and a rotation driving process of rotationally driving the information recording medium on the basis of the read allowance information.

According to the information reproducing method of the present invention, it is possible to receive the same benefits as those of the information reproducing apparatus of the present invention.

Incidentally, in response to the above-mentioned various aspects of the information reproducing apparatus of the present invention, the information reproducing method of the present invention can also adopt various aspects.

(Computer Program)

The above object of the present invention can be also achieved by a first computer program for recording control to control a computer provided in the above-mentioned information recording apparatus of the present invention (including its various aspects), the computer program making the computer function as at least one portion of the first recording device, the reading device, the rotation driving device, and the first controlling device.

According to the first computer program of the present invention, the above-mentioned information recording apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the above-mentioned various aspects of the information recording apparatus of the present invention, the first computer program of the present invention can also adopt various aspects.

The above object of the present invention can be also achieved by a second computer program for reproduction control to control a computer provided in the above-mentioned information reproducing apparatus of the present invention (including its various aspects), the computer program making the computer function as at least one portion of the reproducing device, the reading device, the rotation driving device, and the first controlling device.

According to the second computer program of the present invention, the above-mentioned information reproducing apparatus of the present invention can be relatively easily realized as a computer reads and executes the computer program from a program storage device, such as a ROM, a CD-ROM, a DVD-ROM, and a hard disk, or as it executes the computer program after downloading the program through a communication device.

Incidentally, in response to the above-mentioned various aspects of the information reproducing apparatus of the present invention, the second computer program of the present invention can also adopt various aspects.

The above object of the present invention can be also achieved by a first computer program product in a computer-readable medium for tangibly embodying a program of instructions executable by a computer provided in the information recording apparatus of the present invention (including its various aspects), the computer program product making the computer function as at least one portion of the first recording device, the reading device, the rotation driving device, and the first controlling device.

According to the first computer program product of the present invention, at least one portion of the first recording device, the reading device, the rotation driving device, and the first controlling device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the first recording device, the reading device, the rotation driving device, and the first controlling device described above.

The above object of the present invention can be also achieved by a second computer program product in a computer-readable medium for tangibly embodying a program of instructions executable by a computer provided in the information reproducing apparatus of the present invention (including its various aspects), the computer program product making the computer function as at least one portion of the reproducing device, the reading device, the rotation driving device, and the first controlling device.

According to the second computer program product of the present invention, at least one portion of the reproducing device, the reading device, the rotation driving device, and the first controlling device of the present invention described above can be embodied relatively readily, by loading the computer program product from a recording medium for storing the computer program product, such as a ROM (Read Only Memory), a CD-ROM (Compact Disc-Read Only Memory), a DVD-ROM (DVD Read Only Memory), a hard disk or the like, into the computer, or by downloading the computer program product, which may be a carrier wave, into the computer via a communication device. More specifically, the computer program product may include computer readable codes to cause the computer (or may comprise computer readable instructions for causing the computer) to function as at least one portion of the reproducing device, the reading device, the rotation driving device, and the first controlling device described above.

These effects and other advantages of the present invention become more apparent from the following embodiments.

As explained above, according to the information recording medium of the present invention, it is provided with the allowance information recorded, the allowance information indicating the allowable number of revolutions. Therefore, it is possible to properly control the rotational speed of the information recording medium.

According to the information recording apparatus of the present invention, it is provided with; the first recording device; the reading device; the rotation driving device; and the first controlling device, and according to the information recording method of the present invention, it is provided with; the reading process; and the rotation driving process. Therefore, it is possible to properly record the record information while properly controlling the rotational speed of the information recording medium.

According to the information reproducing apparatus of the present invention, it is provided with: the reproducing device; the reading device; the rotation driving device; and the first controlling device, and according to the information reproducing method of the present invention, it is provided with: the reading process; and the rotation driving process. Therefore, it is possible to properly reproduce the record information while properly controlling the rotational speed of the information recording medium.

### BRIEF DESCRIPTION OF DRAWINGS

FIG. 1 is a substantial plan view showing the basic structure of an optical disc as an embodiment of the information recording medium of the present invention, the optical disc having a plurality of recording areas, in the upper part, in association with a schematic conceptual view showing a recording area structure in the radial direction in the lower part.

FIG. 2 is a graph conceptually showing a relationship among the number of revolutions (rotational speed) of the optical disc, a radial position, and a recording speed or reproduction speed.

FIG. 3 is a table conceptually showing one specific example of allowance information recorded onto the information recording medium in the embodiment, and a graph conceptually showing the number of revolutions (rotational speed) of the optical disc, and the recording speed or reproduction speed, which are controlled on the basis of the allowance information.

FIG. 4 are tables conceptually showing another specific example of the allowance information recorded onto the information recording medium in the embodiment, and a graph conceptually showing the number of revolutions (rotational speed) of the optical disc, and the recording speed or reproduction speed, which are controlled on the basis of the allowance information.

FIG. 5 is a table conceptually showing another specific example of the allowance information recorded onto the information recording medium in the embodiment, and a graph conceptually showing the number of revolutions (rotational speed) of the optical disc, and the recording speed or reproduction speed, which are controlled on the basis of the allowance information.

FIG. 6 are tables conceptually showing another specific example of the allowance information recorded onto the information recording medium in the embodiment, and a graph conceptually showing the number of revolutions (rotational speed) of the optical disc, and the recording speed or reproduction speed, which are controlled on the basis of the allowance information.

FIG. 7 are tables conceptually showing another specific example of the allowance information recorded onto the information recording medium in the embodiment, and a graph conceptually showing the number of revolutions (rotational speed) of the optical disc, and the recording speed or reproduction speed, which are controlled on the basis of the allowance information.

FIG. 8 are data structure diagrams conceptually showing an aspect of recording the allowance information onto the information recording medium in the embodiment.

FIG. 9 are a table or a graph conceptually showing one example of the allowance information recorded onto an information recording medium related to a CLV recording method, out of the information recording medium in the embodiment.

FIG. 10 are a table or a graph conceptually showing one example of the allowance information recorded onto an information recording medium related to a Z-CLV recording method, out of the information recording medium in the embodiment.

FIG. 11 are a table or a graph conceptually showing one example of the allowance information recorded onto an information recording medium related to a Z-CAV recording method, out of the information recording medium in the embodiment.

FIG. 12 is a block diagram conceptually showing the basic structure of an information recording/reproducing apparatus, as an embodiment of the information recording apparatus or the information reproducing apparatus of the present invention.

FIG. 13 is a flowchart showing a flow of an entire first operation example of the information recording/reproducing apparatus in the embodiment.

FIG. 14 is a flowchart showing a flow of an operation of setting the upper limit of the number of revolutions, out of the first operation example of the information recording/reproducing apparatus in the embodiment.

FIG. 15 is a flowchart showing a flow of an operation of setting the upper limit of the number of revolutions, out of a second operation example of the information recording/reproducing apparatus in the embodiment.

FIG. 16 is a flowchart showing a flow of a crack detection operation, out of the second operation example of the information recording/reproducing apparatus in the embodiment.

### DESCRIPTION OF REFERENCE CODES

1 information recording/reproducing apparatus
100 optical disc
104 lead-in area
108 lead-out area
501 optical pickup
502 spindle motor
503 head amplifier
524 dropout detector
525 error rate detector
526 vibration/sound sensor
540 servo unit
560 CPU

### BEST MODE FOR CARRYING OUT THE INVENTION

Hereinafter, the best mode for carrying out the present invention will be explained in each embodiment in order, with reference to the drawings.

### Embodiment of Information Recording Medium

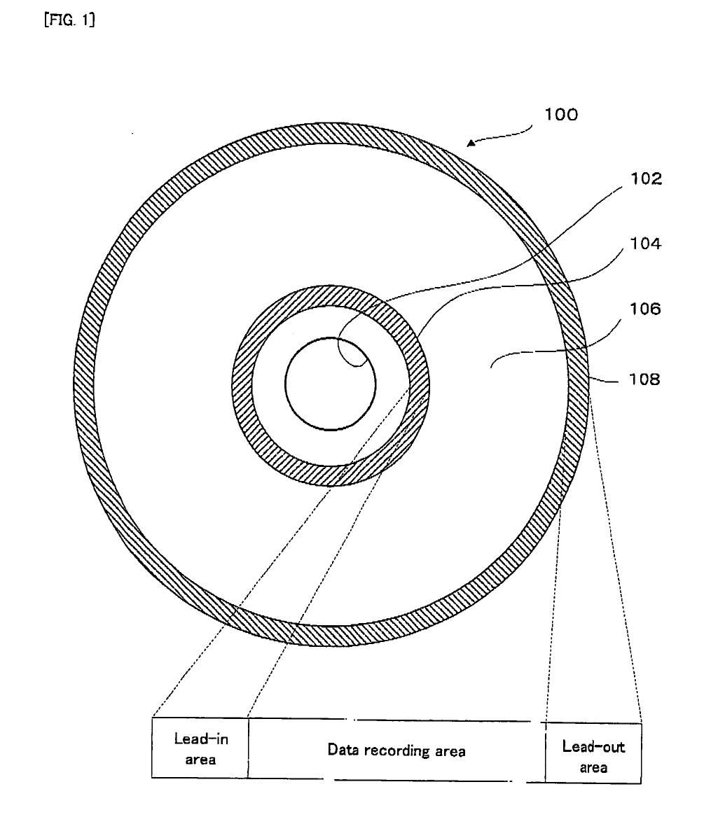

Firstly, an optical disc as an embodiment of the information recording medium of the present invention will be explained, with reference to FIG. 1 to FIG. 11.

First, with reference to FIG. 1, the basic structure of the optical disc in the embodiment will be explained. FIG. 1 is a substantial plan view showing the structure of the optical disc having a plurality of recording areas, in the upper part, in association with a schematic conceptual view showing a recording area structure in the radial direction in the lower part.

As shown in FIG. 1, an optical disc 100 is recordable in various recording methods, such as a magneto optical method and a phase change method, on which recording (writing) can be performed a plurality of times or only once, for example. The optical disc 100 has a recording surface on a disc main body with a diameter of about 12 cm, as is a DVD. On the recording surface, the optical disc 100 is provided with: a center hole 102 as the center; a lead-in area 104; a data recording area 106; and a lead-out area 108, from the inner to the outer circumference, in a CLV (Constant Linear Velocity), for example. In each area, a groove track and a land track are alternately placed, spirally or concentrically, centered on the center hole 102, for example. The groove track may be wobbled, and a pre-pit may be formed on one or both of the tracks. Incidentally, the present invention is not particularly limited to the optical disc having these three areas. For example, even if the lead-in area 104 or the lead-out area 108 does not exist, a file structure explained below can be constructed. Moreover, as described later, the lead-in area 104 or the lead-out area 108 may be further segmentized.

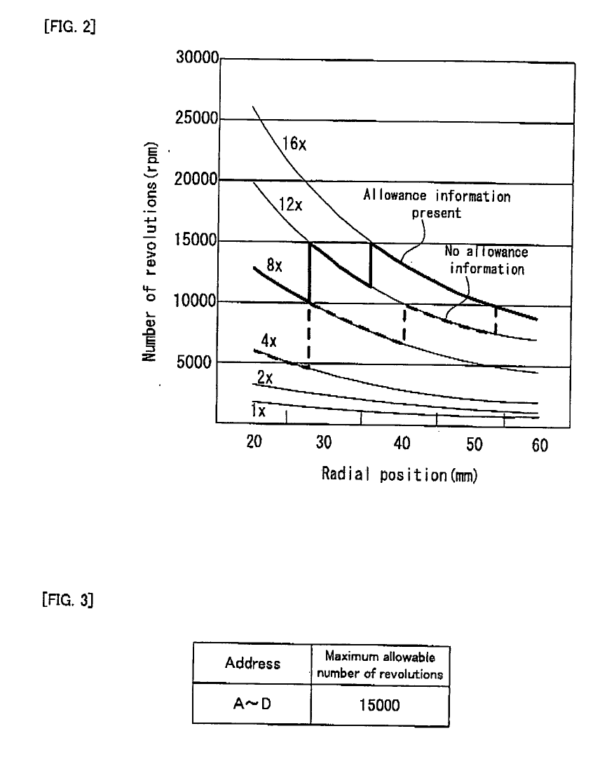

Next, with reference to FIG. 2 to FIG. 7, the optical disc in the embodiment will be explained in more detail. In particular, allowance information recorded on the optical disc 100 will be explained in more detail. FIG. 2 to FIG. 7 are tables conceptually showing specific examples of the allowance information, or graphs conceptually showing the number of revolutions (rotational speed) of the optical disc, controlled on the basis of the allowance information, or the recording speed or reproduction speed.

Normally, in the data recording or data reproduction performed on the optical disc, there is dependency on the linear velocity of the optical disc. In general, the recording or reproduction is performed at a recording speed or reproduction speed with a determined value, such as a recording speed (reproduction speed) of 1×, which is a reference in the case where a certain linear velocity is based, a double speed of 2×, and a higher speed of 4×. This is because a recording parameter, which is referred to as a recording strategy, or another reproduction parameter in each linear velocity (or recording speed or the like) is different, and it rarely varies continuously from 1× to 4×.

FIG. 2 shows a radial position and the number of revolutions of the optical disc in each radial position in the case of a linear velocity of 3.4 m/sec when the data is recorded. Moreover, each graph corresponds to respective one of recording speeds (reproduction speeds) of 1×, 2×, 4×, 8×, 12×, and 16×.

On the optical disc 100 in the embodiment, the allowance information indicating the maximum allowable number of revolutions, which is the maximum allowable value of the number of revolutions of the optical disc 100, is recorded. Specifically, in the case of the allowable information shown in FIG. 3, the allowable information determines that the number of revolutions of the optical disc 1000 has an upper limit of 15000 rpm. At this time, the maximum allowable number of revolutions may be constructed so as to be indicated with designating the address of the optical disc 100 (e.g. an address “A” corresponding to the innermost circumference of the optical disc 100 to an address “D” of the optical disc 100), as shown in FIG. 3. Alternatively, if it is only necessary to designate the maximum allowable number of revolutions with respect to the entire optical disc 100, the maximum allowable number of revolutions may be constructed so as to be indicated with not designating the address. Therefore, if the data is recorded onto the optical disc 100 on the basis of the allowance information shown in FIG. 3, or if the data recorded on the optical disc 100 is reproduced on the basis of the allowance information shown in FIG. 3, as shown in a thick solid line in FIG. 2, the data can be recorded or reproduced at the recording speed (reproduction speed) of 8× from the inner circumference to a radial position of about 30 mm, and the data can be recorded or reproduced at the recording speed (reproduction speed) of 12× from the radial position of about 30 mm to about 35 mm, and the data can be recorded or reproduced at the recording speed (reproduction speed) of 16× in the rest of radial positions (i.e. over a radial position of 35 mm).

On the other hand, as in a conventional DVD, if such allowance information is not recorded, an information recording/reproducing apparatus described later rotationally drives the optical disc 100 at 10000 rpm, which is the number of revolutions recommended in the standard of the optical disc 100, for example. In this case, as shown in a thick dashed line in FIG. 2, the data can be recorded or reproduced at the recording speed (reproduction speed) of 4× from the inner circumference to a radial position of about 30 mm, and the data can be recorded or reproduced at the recording speed (reproduction speed) of 8× from the radial position of about 30 mm to about 40 mm, and the data can be recorded or reproduced at the recording speed (reproduction speed) of 12× from the radial position of about 40 mm to about 52 mm, and the data can be only recorded or reproduced at the recording speed (reproduction speed) of 16× in the rest of radial positions (i.e. from the radial position of 52 mm to the outermost circumference of 59 mm).

Namely, even if the number of revolutions more than the number of revolutions recommended in the standard can be realized with the advancement of technology, for example, it is hardly possible to rotationally drive the optical disc 100 at this number of revolutions more than the number of revolutions recommended in the standard. Along with this, it is difficult or impossible to realize a relatively high recording speed or reproduction speed (which is hereinafter referred to as a “recording speed or the like”), e.g. 16-time speed, 24-time speed, etc. Alternatively, only in the case where the data is recorded into or reproduced from a partial recording area of the optical disc, it is possible to rotationally drive the optical disc 100 at this number of revolutions more than the number of revolutions recommended in the standard. Thus, there is such a technical problem that the relatively high recording speed or the like can be realized only in the partial recording area, for example, in the outermost circumference having the width of about 8 mm in the case of 16×. In the embodiment, however, the allowance information indicating the allowable number of revolutions (i.e. the maximum allowable number of revolutions) is recorded on the optical disc 100 itself. Thus, by referring to the allowance information to thereby record or reproduce the data, it is possible to relatively easily enable the information recording/reproducing apparatus described later, to identify whether or not the optical disc 100 can be rotationally driven at the number of revolutions more than the number of revolutions recommended in the standard (e.g. 10000 rpm, etc.). Therefore, there is such a great advantage that the relatively high recording speed or the like can be realized. In particular, on the basis of the allowance information, it is possible to identify whether or not the optical disc 100 can be rotationally driven at the number of revolutions more than the number of revolutions recommended in the standard, on the entire optical disc 100. Thus, there is such a great advantage that the relatively high recording speed or the like can be realized in the entire recording area of the optical disc 100.

Incidentally, even if the allowance information is recorded, the recording speed reproduction speed) may not be always changed as shown in the thick solid line in FIG. 2. For example, even if the allowance information is recorded, the recording speed (reproduction speed) may be changed as shown in the thick dashed line in FIG. 2, in view of a data recording time length (reproduction time length) and realization of the stable operation of the information recording/reproducing apparatus described later.

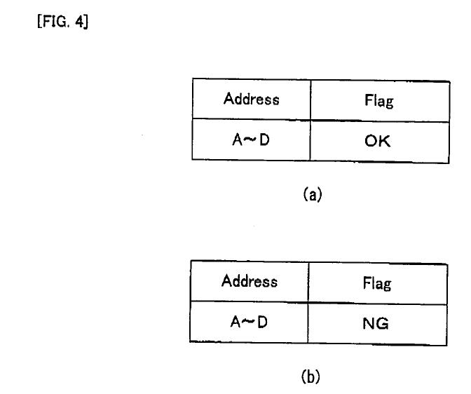

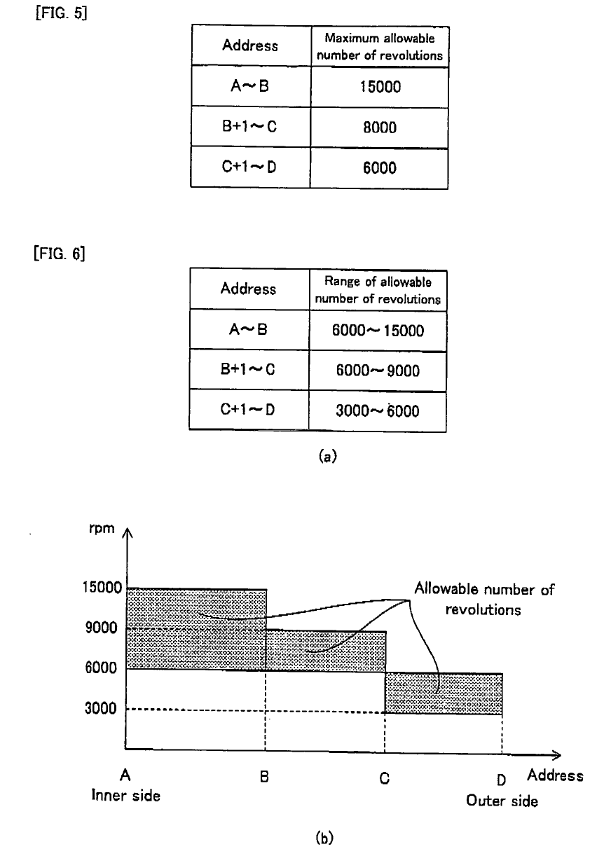

The allowance information is not necessarily constructed to indicate the absolute value of the maximum allowable number of revolutions, as described above, but may be a flag indicating whether or not the optical disc 100 can be rotated at the number of revolutions more than predetermined number of revolutions, as shown in FIG. 4(a) and FIG. 4(b). For example, it is assumed that the predetermined number of revolutions is set in advance to 10000 rpm. If the optical disc 100 can be rotationally driven at the number of revolutions more than 10000 rpm, as shown in FIG. 4(a), “OK” or “1” flag may be recorded onto the optical disc 100 as the allowance information, for example. On the other hand, if the optical disc 100 cannot be rotationally driven at the number of revolutions more than 10000 rpm, as shown in FIG. 4(b), “NG” or “0” flag may be recorded onto the optical disc 100 as the allowance information, for example. At this time, preferably, information indicating the predetermined number of revolutions is also recorded on the optical disc 100, as one portion of the allowance information, or as independent information.

Then, in the case where the optical disc 100 is rotationally driven on the basis of the allowance information indicated by the flag, it is possible to receive the same benefits as in the case where the optical disc 100 is rotationally driven on the basis of the above-mentioned allowance information indicated by the absolute value of the maximum allowable number of revolutions.

Incidentally, the allowance information indicated by the flag may not be a flag for certain one kind of the number of revolutions, but it may be a flag for a plurality of kinds of the number of revolutions, such as two or more types, for example. For example, if the predetermined number of revolutions is set in advance to 10000 rpm and 100 rpm, there may be a flag indicating whether or not the optical disc 100 can be rotationally driven at the number of revolutions more than 10000 rpm and a flag indicating whether or not the optical disc can be rotationally driven at the number of revolutions more than 15000 rpm, as the allowance information.

Then, if the allowance information indicates that the optical disc 100 can be rotationally driven at the number of revolutions more than 10000 rpm whereas the optical disc 100 cannot be rotationally driven at the number of revolutions more than 15000 rpm, it is possible to set the number of revolutions which is 10000 rpm or more and 15000 rpm or less, in an operation of setting the upper limit of the number of revolutions, performed by the information recording/reproducing apparatus described later, for example. Namely, as compare to the allowance information having the flag merely for one kind of the number of revolutions, the information recording/reproducing apparatus can more preferably recognize the upper limit of the number of revolutions at which the optical disc 100 can be rotationally driven, more preferably.

Moreover, as shown in FIG. 5, the allowance information may indicate the maximum allowable number of revolutions in each recording area (e.g. in each radial position) of the optical disc 100. For example, as shown in FIG. 5, the allowance information may indicate that the maximum allowable number of revolutions is 15000 rpm in a recording area expressed by an address “A” to an address “B”, the maximum allowable number of revolutions is 8000 rpm in a recording area expressed by an address “B+1” to an address “C”, and the maximum allowable number of revolutions is 6000 rpm in a recording area expressed by an address “C+1” to an address “D”. Of course, the method of separating the recording area is not limited to be the one based on the address, and if it is a method of properly separating the recording area of the optical disc 100, it is included in the scope of the present invention.

Moreover, the allowance information does not necessarily indicate the maximum number of revolutions which can be allowed (i.e. the maximum allowable number of revolutions) As shown in FIG. 6(a), for example, the allowance information may be constructed to indicate a range of the number of revolutions which can be allowed (hereinafter referred to as allowable number of revolutions or the like). The allowance information shown in FIG. 6(a) indicates that the range of the allowable number of revolutions is 6000 rpm to 15000 rpm in the recording area expressed by the address “A” to the address “B”, the range of the allowable number of revolutions is 6000 rpm to 9000 rpm in the recording area expressed by the address “B+1” to the address “C”, and the range of the allowable number of revolutions is 3000 rpm to 6000 rpm in the recording area expressed by the address “C+1” to the address “D”.

By rotationally driving the optical disc 100 on the basis of the allowance information, it is possible to relatively easily identify the number of revolutions at which the rotation can be actually performed in each recording area of the optical disc 100, as shown in FIG. 6(b). Along with this, there is such a great advantage that it is possible to preferably realize the relatively high recording speed or the like, as described above.

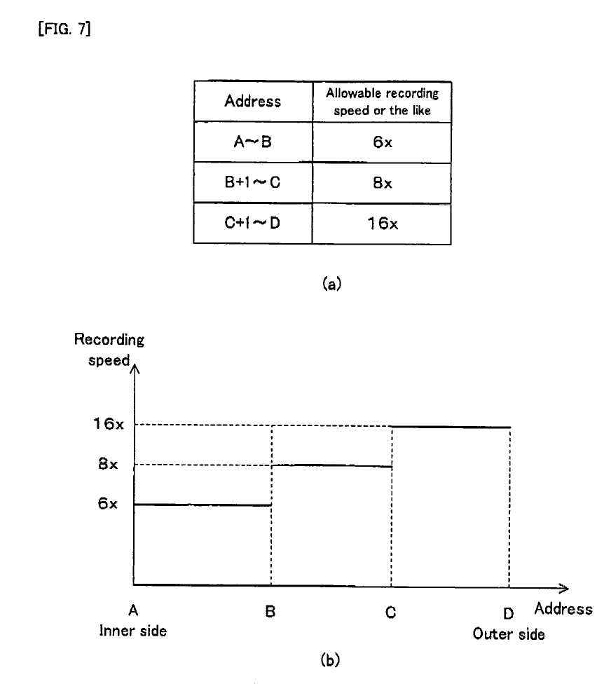

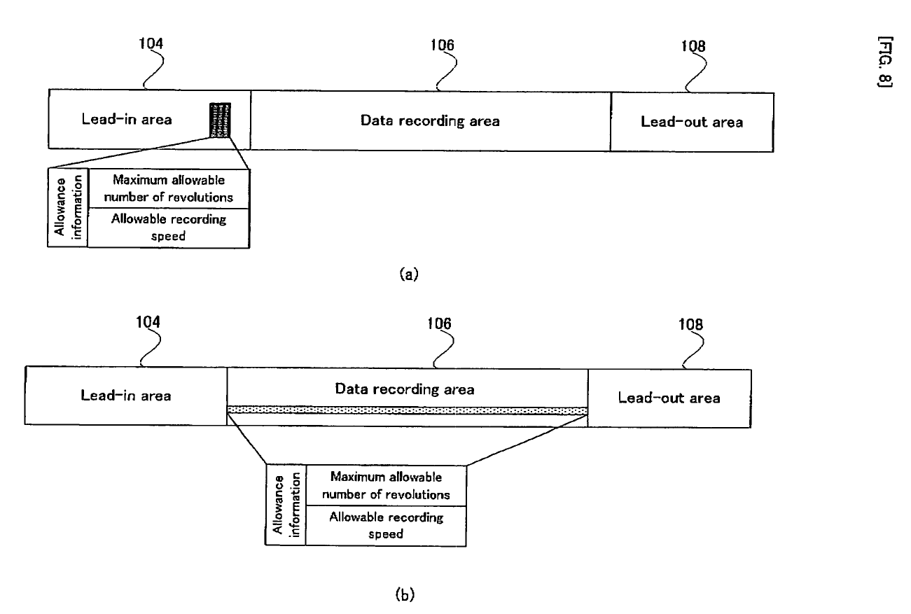

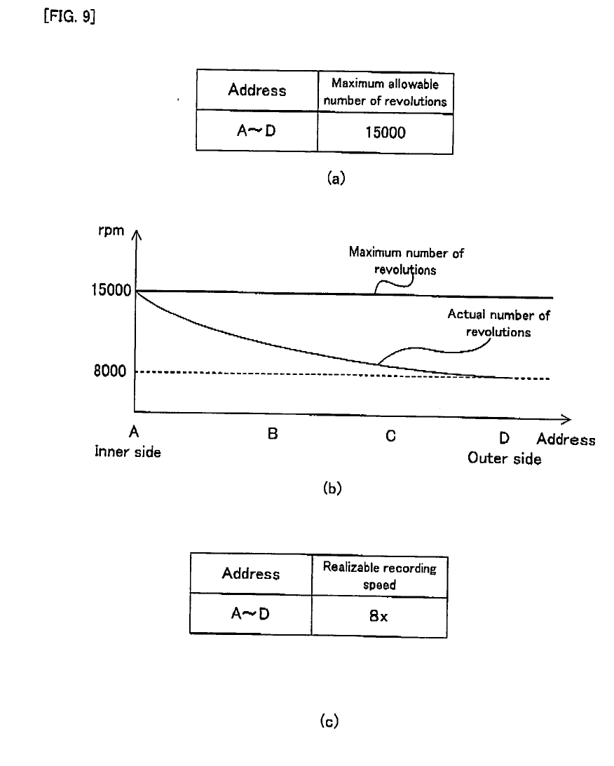

Moreover, the allowance information does not necessarily indicate the maximum number of revolutions which can be allowed (i.e. the maximum allowable number of revolutions) As shown in FIG. 7(a), for example, the allowance information may be constructed to show the recording speed or the like which can be realized (i.e. which can be allowed) (hereinafter referred to as a realizable recording speed or the like). The allowance information shown in FIG. 7(a) indicates that the realizable recording speed or the like is 6× (i.e. 6-time speed) in the recording area expressed by the address “A” to the address “B”, the realizable recording speed or the like is 8× (i.e. 8-time speed) in the recording area expressed by the address “B+1” to the address “C”, and the realizable recording speed or the like is 16× (i.e. 16-time speed) in the recording area expressed by the address “C+1” to the address “D”. Namely, this allowance information indicates that the recording speed or the like increases with movement from the inner to the outer circumferential side, as shown in FIG. 7(b).

By recording the data onto the optical disc 100 on the basis of such allowance information, or by reproducing the data recorded on the optical disc 100 on the basis of such allowance information, it is possible to properly control the recording speed, and it is possible to realize the relatively high recording speed or the like. Moreover, controlling the recording speed also means rotationally driving the optical disc 100 while controlling the number of revolutions of the optical disc 100, so that the information recording/reproducing apparatus can preferably rotationally drive the optical disc 100, for example. Namely, it is possible to enable the information recording/reproducing apparatus described later to relatively easily recognize that the optical disc 100 can be rotationally driven at the number of revolutions more than 10000 rpm, for example. Thus, it is possible to receive the above-mentioned various benefits.

Of course, it is obvious that the allowance information may not indicate the realizable recording speed or the like in each recording area of the optical disc 100 but indicate the realizable recording speed in the entire optical disc 100. Moreover, as the realizable recording speed, it may be information indicating the maximum value of the realizable recording speed, or it may be information indicating a range of the realizable recording speed.

Incidentally, as the information indicated by the allowance information, it is not limited to the examples shown in the above-mentioned embodiment. Information directly or indirectly indicating the allowable number of revolutions and/or the realizable recording speed will do.

Now, an aspect of actually recording the allowance information onto the optical disc 100 is specifically explained, with reference to FIG. 8. FIG. 8 are data structure diagrams conceptually showing the aspect of recording the allowance information onto the optical disc 100.

As shown in FIG. 8(a), the allowance information may be recorded into a predetermined recording area in the lead-in area 104. By virtue of such construction, if the optical disc 100 is loaded on the information recording/reproducing apparatus described later, for example, in obtaining various management data required for the data recording or reproduction from the lead-in area 104, it is also possible to obtain the allowance information together. Therefore, without giving an influence to the normal recording operation or reproduction operation, it is possible to properly perform the recording operation or reproduction operation, on the basis of the allowance information.

Moreover, as shown in FIG. 8(b), the allowance information may be distributed and recorded in the entire data recording area 106 or in at least one portion thereof. Specifically, in a DVD-R/RW or the like as one specific example of the optical disc 100, for example, the allowance information may be recorded by an LPP (Land Pre Pit) formed on the land track, for example. In this case, together with address information indicated by the LPP, the allowance information (more preferably, the maximum allowable number of revolutions in accordance with the address information) is preferably recorded. Alternatively, in a DVD+R/RW or the like as another specific example of the optical disc 100, the allowance information may be recorded by performing predetermined modulation on wobble, which corresponds to the winding of the land track or the groove track, for example.

Moreover, as shown in the above-mentioned FIG. 5, FIG. 6 and FIG. 7, in the case of the allowance information indicating the maximum allowable number of revolutions or the like in each recording area, the maximum allowable number of revolutions corresponding to each recording area (or the entire allowance information) may be recorded in each recording area.

As described above, by recording the allowance information into the data recording area 106, the information recording/reproducing apparatus described later, for example, can perform the operation of recording or reproducing the data, and also rotationally drive the optical disc 100 on the basis of the allowance information. Namely, it can obtain the allowance information while obtaining the address information associated with the data recording or reproduction operation, so that it is possible to rotationally drive the optical disc 100 with the progress of the recording operation or reproduction operation.

Of course, the recording of the allowance information is not limited to into the lead-in area 104 and the data recording area 106, but the allowance information may be recorded into the lead-out area 108 or other areas, for example.

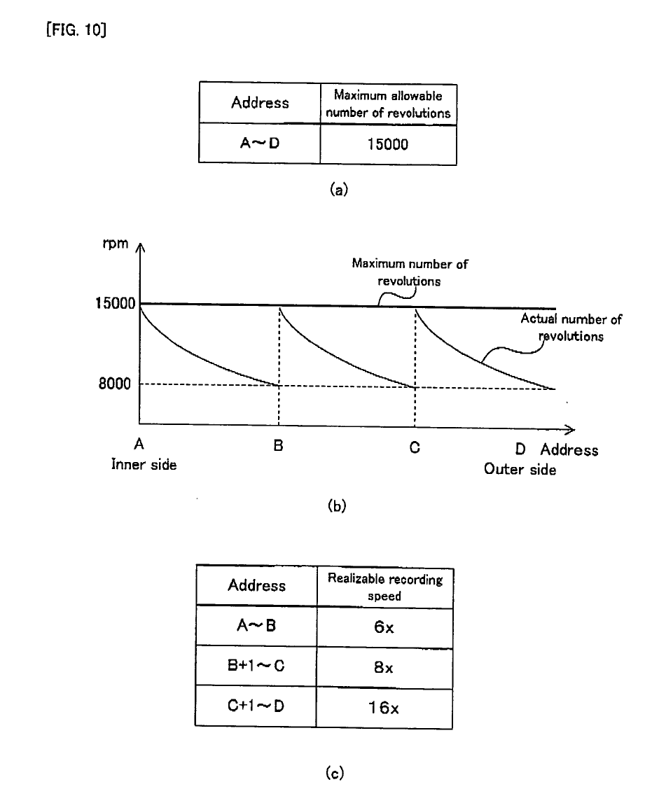

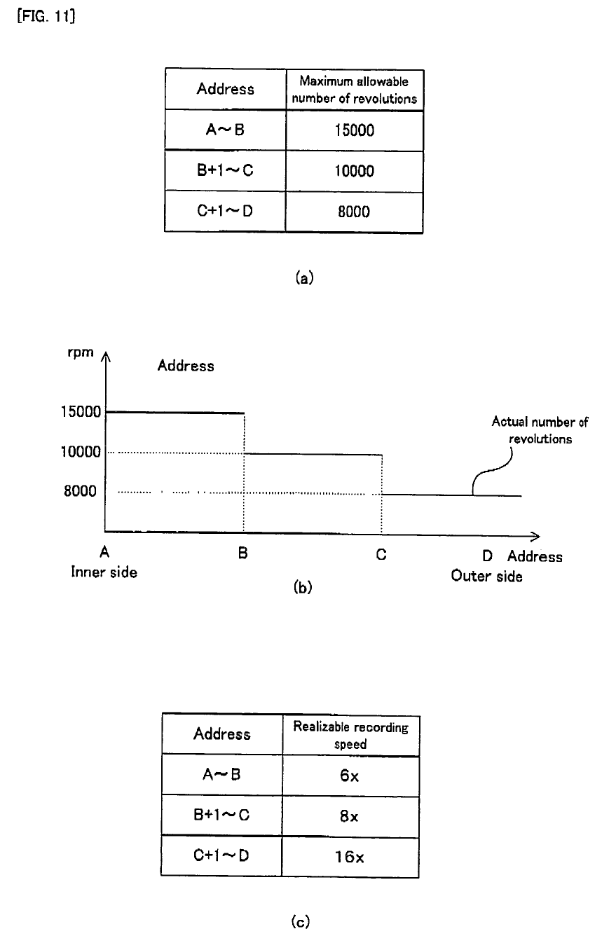

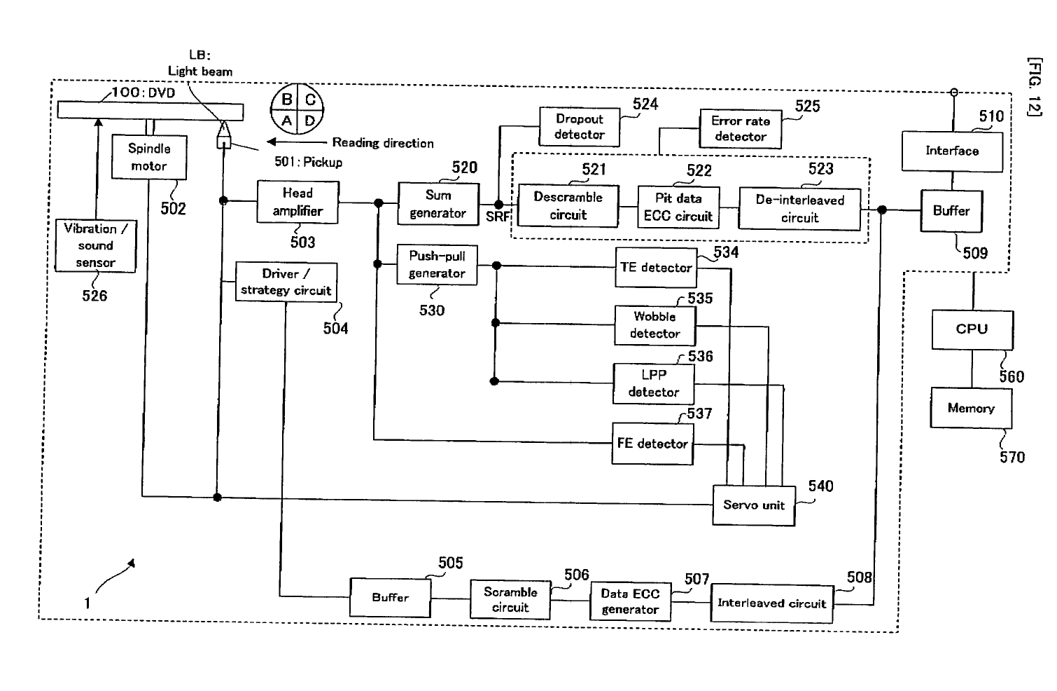

Next, with reference to FIG. 9 to FIG. 11, specific examples of the allowance information will be explained in each data recording method on the optical disc 100 (specifically, e.g., a CLV (Constant Linear Velocity) recording method, a Z-CLV (Zone-CLV) recording method, a Z-CAV (Zone-Constant Angular Velocity) recording method). Incidentally, in the above-mentioned FIG. 3, the explanations about respective recording methods are described all together FIG. 9 are a table or a graph conceptually showing one example of the allowance information recorded onto the optical disc 100 in the CLV recording method. FIG. 10 are a table or a graph conceptually showing one example of the allowance information recorded onto the optical disc 100 in the Z-CLV recording method. FIG. 11 are a table or a graph conceptually showing one example of the allowance information recorded onto the optical disc 100 in the Z-CAV recording method.

The CLV recording method is to rotationally drive the optical disc 100 so as to set the linear velocity to be constant on the entire optical disc 100. In this case, the optical disc 100 is rotationally driven such that the number of revolutions decreases with movement from the inner to the outer circumferential side of the optical disc 100.

At this time, as shown in FIG. 9(a), the allowance information indicating the maximum allowable number of revolutions on the entire optical disc 100 is preferably recorded on the optical disc 100, for example. By this, as shown in the graph in FIG. 9(b) for example, the information recording/reproducing apparatus described later can record or the like the data in the CLV recording method and can also rotationally drive the optical disc 100 at the number of revolutions less than 15000 rpm, for example, on the basis of the allowance information.

Moreover, as shown in FIG. 9(c), the allowance information indicating the realizable recording speed may be further recorded.

The ZCLV recording method is to rotationally drive the optical disc 100 so as to set the linear velocity to be constant in each certain recording area (i.e. zone).

At this time, as shown in FIG. 10(a), the allowance information indicating the maximum allowable number of revolutions on the entire optical disc 100 may be recorded on the optical disc 100, for example. Of course, the allowance information indicating the maximum allowable number of revolutions in each zone in which the linear velocity is constant, may be recorded on the optical disc 100. By this, as shown in the graph in FIG. 10(b) for example, the information recording/reproducing apparatus described later can record or the like the data in the ZCLV recording method and can also rotationally drive the optical disc 100 at the number of revolutions less than 15000 rpm, for example, on the basis of the allowance information.

Incidentally, with regard to the optical disc 100 related to the ZCLV recording method, as shown in FIG. 10(c), the allowance information indicating the realizable recording speed in each zone is more preferably recorded. By performing the operation of data recording or the like with reference to the allowance information, it is possible to preferably change the recording speed in each zone, and it is possible to realize the more proper recording operation.

Incidentally, with regard to the realizable recording speed in each zone, the allowance information may be recorded in each zone. Namely, the allowance information shown in FIG. 10(c) may be recorded in each of a zone expressed by the address “A” to the address “B”, a zone expressed by the address “B+1” to the address “C”, and a zone expressed by the address “C+1” to the address “D”. Alternatively, the recording speed corresponding to each zone (i.e. the realizable recording speed) may be recorded. Namely, the allowance information indicating the corresponding recording speed of “6×” may be recorded in the zone expressed by the address “A” to the address “B”, and the allowance information indicating the corresponding recording speed of “8×” may be recorded in the zone expressed by the address “B+1” to the address “C”, and the allowance information indicating the corresponding recording speed of “16×” may be recorded in the zone expressed by the address “C+1” to the address “D”.

The ZCAV recording method is to control the rotational speed so as to set the number of revolutions (i.e. angular velocity) to be constant in each certain recording area (i.e. zone) of the optical disc 100.

At this time, as shown in FIG. 11(a), the allowance information indicating the maximum allowable number of revolutions in each zone is preferably recorded on the optical disc 100. Of course, the allowance information indicating the maximum allowable number of revolutions on the entire optical disc 100 may be also recorded on the optical disc 100. By this, the information recording/reproducing apparatus described later can record or the like the data by the ZCAV recording method, as shown in FIG. 11(b), for example. At the same time, it can also rotationally drive the optical disc 100 at the number of revolutions less than 15000 rpm (or at 15000 rpm), for example, when recording or the like the data into the zone expressed by the address “A” to the address “B”, and at the number of revolutions less than 10000 rpm (or at 10000 rpm), for example, when recording or the like the data into the zone expressed by the address “B+1” to the address “C”, and at the number of revolutions less than 800 rpm (or at 8000 rpm), for example, when recording or the like the data into the zone expressed by the address “C+1” to the address “D”, on the basis of the allowance information.

Incidentally, on the optical disc 100 related to the ZCAV recording method, as shown in FIG. 11(c), the allowance information indicating the realizable recording speed in each zone (or on the entire optical disc 100) may be recorded. By performing the operation of data recording or the like with reference to the allowance information, it is possible to preferably change the recording speed (or record or the like the data at the preferable recording speed), and it is possible to realize the more proper recording operation.

### Embodiment of Information Recording/Reproducing Apparatus

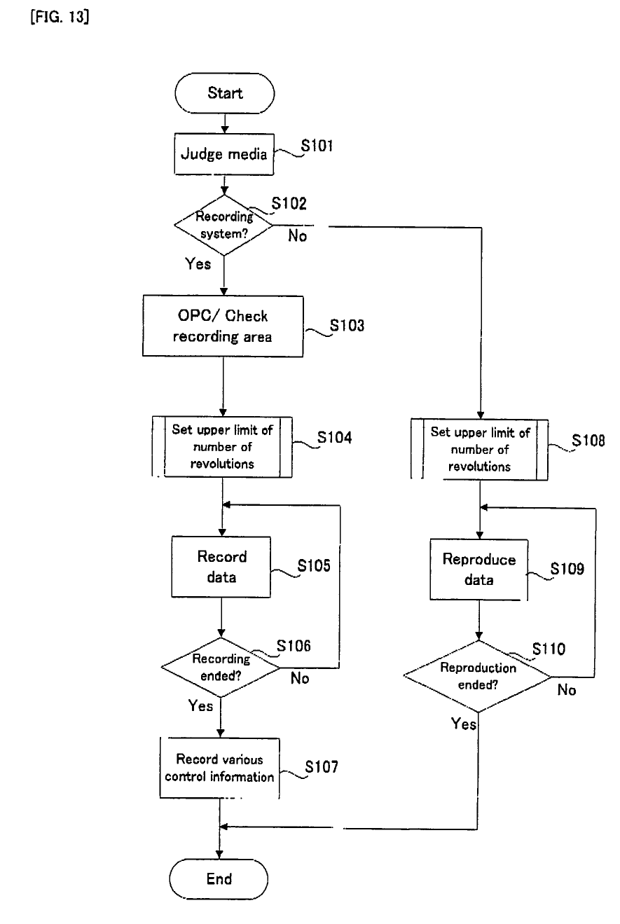

Next, with reference to FIG. 12 to FIG. 16, an information recording/reproducing apparatus as an embodiment of the information recording apparatus or the information reproducing apparatus of the present invention will be explained.

(1) Basic Structure

Firstly, with reference to FIG. 12, the basic structure of the information recording/reproducing apparatus in the embodiment will be explained. FIG. 12 is a block diagram conceptually showing the basic structure of the information recording apparatus in the embodiment of the present invention.

As shown in FIG. 12, an information recording/reproducing apparatus 1 is provided with: an optical pickup 501; a spindle motor 502; a head amplifier 503; a driver/strategy circuit 504; a buffer 505; a scramble circuit 506; a data ECC (Error Correction Code) generator 507; an interleaved circuit 508; a buffer 509; an interface 510; a sum generator 520; a descramble circuit 521; a pit data ECC circuit 522; a de-interleaved circuit 523; a dropout detector 524; an error rate detector 525; a vibration/sound sensor 526; a push-pull generator 530; a TE (Tracking Error) detector 534; a wobble detector 535; an LPP (Land Pre Pit) detector 536; a FE (Focus Error) detector 537; a servo unit 540; a CPU 560; and a memory 570.

The optical pickup 501 is one specific example of the “first recording device”, the “second recording device”, and the “reproducing device” of the present invention. The optical pickup 501 is to perform the recording/reproduction with respect to the optical disc 100. The optical pickup 501 is provided with a semiconductor laser device, various lenses, an actuator and the like. More specifically, the optical pickup 501 irradiates the optical disc 100 with a light beam B, such as laser light, with a first power as reading light at the time of reproduction, and with a second power as writing light, with it modulated, at the time of recording. The optical pickup 501 is constructed to be displaced in the radial direction of the optical disc 100 or the like, in accordance with tracking servo, by a not-illustrated actuator, slider, or the like driven by the control of the servo unit 540. In addition, the optical pickup 501 is constructed to change focus of the light beam B in accordance with focus servo, to thereby focus-control it, under the control of the servo unit 540.

Moreover, the optical pickup 501 is provided with a not-illustrated four-division detection circuit. The four-division detection circuit divides the reflected light of the laser beam B into four areas A, B, C, and D shown in the upper part of FIG. 12, and outputs each signal corresponding to the quantity of light in respective one of the areas.

The spindle motor 502 is one specific example of the “rotation driving device” of the present invention. The spindle motor 502 is constructed to rotate the optical disc 100 at a predetermined speed under spindle servo from the servo unit 540 or the like.

The head amplifier 503 is one specific example of the “reading device” of the present invention. The head amplifier 503 amplifies each output signal of the optical pickup 501 (i.e. the reflected light of the light beam B), and outputs a divisional read signal a corresponding to the area A, a divisional read signal b corresponding to the area B, a divisional read signal c corresponding to the area C, and a divisional read signal d corresponding to the area D.

The driver/strategy circuit 504 drives the semiconductor laser built in the optical pickup 501 in order to determine an optimum recording power. Then, the driver/strategy circuit 504 is constructed to drive the semiconductor laser of the optical pickup 501, with the optimum recording laser power, determined by the above-mentioned OPC (Optical Power Calibration) process, for example, at the time of data recording. At the time of data recording, the optimum laser power is modulated in accordance with the record data.

Incidentally, the OPC process is a process of detecting an optimum recording laser power (i.e. a process of calibrating a recording laser power). More specifically, a short pit corresponding to a 3T pulse and a long pit corresponding to an 11T pulse, for example, are formed in a PCA (Power Calibration Area) disposed in the lead-in area 104, for example, alternately, with respective unrecorded sections having the same length. By performing this operation with 16 different laser powers, for example, the recording power is calculated to perform the recording so as to minimize an influence of asymmetry and so as to obtain the most excellent reproduction quality.

The buffer 505 is constructed to store therein the record data modulated by the scramble circuit 506, and output it to the driver/strategy circuit 504.

The scramble circuit 506 is constructed to perform a scramble process in which the order of the record data is rearranged in accordance with a predetermined rule, and also perform DVD modulation, for example, on the scrambled record data, and output it to the buffer 505. As the DVD modulation, for example, 8-16 modulation may be performed.

The data ECC generator 507 appends a code for error correction, to the record data interleaved on the interleaved circuit 508. Specifically, the data ECC generator 507 appends an ECC code by each predetermined block unit (e.g. an ECC cluster unit), and outputs it to the scramble circuit 508.

The interleaved circuit 508 is constructed to perform an interleaved process on the record data inputted from the interface 510. Incidentally, as one specific example of the interleaved process, there is listed a process of changing the arrangement of the record data, as occasion demands, so that data errors are distributed.

The buffer 509 buffers the record data inputted from the interface 510 and outputs it to the interleaved circuit 508, as occasion demands. Moreover, the buffer 509 buffers reproduction data outputted from the de-interleaved circuit 523 and outputs it to external output equipment through the interface 510, as occasion demands.

The interface 510 is constructed to receive an input of the record data or the like, from external input equipment, and output the reproduction data to the external output equipment.

Therefore, at the time of normal data recording, an ECC is appended on the data ECC generator 507 to a record signal inputted from the interface through the buffer 508, and then it is scrambled or DVD-modulated on the scramble circuit 506. Then, by outputting it to the driver/strategy circuit 504 through the buffer 505, the optical pickup is driven with the optimum recording power, to thereby perform the recording on the optical disc 100. Namely, a circuit system including the optical pickup 501, the driver/strategy circuit 504, the buffer 505, the scramble circuit 506, the data ECC generator 507, the interleaved circuit 508, the buffer 509, and the interface 510, constitutes one specific example of the “information recording apparatus” of the present invention.

The sum generation circuit 520 is provided with an addition circuit for adding the divisional read signals a, b, c, and d and for outputting a sum read signal SRF. Incidentally, the sum read signal SRF is a signal which represents the length of the record mark.

The descramble circuit 521 reproduces pit data on the basis of the sum read signal SRF. More specifically, the descramble circuit 521 demodulates the reproduced pit data by using a predetermined table, with a synchronization signal for reproduction as a reference position, to thereby generate the reproduction data. For example, if 8-16 modulation is adopted as a modulating method, a process of converting 16-bit pit data to 8-bit reproduction data is performed. Then, a descramble process is performed in which the order of the reproduction data is rearranged in accordance with a predetermined rule, and the processed reproduction data is outputted.

The pit data ECC circuit 522 performs an error correction process and an interpolation process or the like, on the reproduction data generated on the descramble circuit 521. Then, the reproduction data is outputted to the interface 510 through the buffer 509, and is reproduced on the external output equipment, such as a speaker and a display.

The de-interleaved circuit 523 is constructed to perform a de-interleaved process on the reproduction data error-corrected or the like on the pit data ECC circuit 522. Specifically, as opposed to the interleaved process on the interleaved circuit 508, a process of returning the changed data arrangement to the original state is performed.

Namely, a circuit system including the optical pickup 501, the head amplifier 503, the descramble circuit 521, the pit data ECC circuit 522, the de-interleaved circuit 523, the buffer 509, and the interface 510, constitutes one specific example of the “information reproducing apparatus” of the present invention.

The dropout detector 524 is constructed to detect whether or not the sum read signal SRF is outputted from the sum generator 520. Then, the detection result, i.e. the indication that the sum read signal SRF is outputted or not outputted, is outputted to the CPU 560, for example.

The error rate detector 525 is constructed to detect the error rate of the data to be reproduced. Specifically it detects the error rate of the data to be reproduced, on the basis of the result of the error correction process and the interpolation process performed by the pit data ECC circuit 522.

The vibration/sound sensor 526 is constructed to detect the vibration (or its vibration or oscillating quantity) of the optical disc 100. At the same time, it is constructed to detect the sound (or quantity, pitch, range, and volume of the sound, etc.) with a microphone or the like, for example.

Incidentally, each of the dropout detector 524, the error rate detector 525, and the vibration/sound sensor 526 corresponds to one specific example of the “detecting device” of the present invention. The detailed operation in this constructions will be described in detail later (refer to FIG. 16).

The push-pull signal generator 530 calculates (a+d)−(b+c) by using a division read signal and generates a push-pull signal. The component (a+d) corresponds to the areas A and D which are on the left side with respect to the reading direction, while the component (b+c) corresponds to the areas B and C which are on the right side with respect to the reading direction. The value of the push-pull signal indicates a relative position relationship between the light beam B and the pit.

The TE detector 534 detects a tracking error from a tracking error signal component, out of the push-pull signal inputted from the push-pull signal generator 530. Then, it outputs the tracking error signal to the servo unit 540.

The wobble detector 535 is constructed to detect a wobble signal component, out of the push-pull signal inputted from the push-pull signal generator 530. Moreover, it also detects relative position information based on a slot unit corresponding to a length which is a natural number multiple of one cycle of the wobble signal for example, on the basis of the cycle of the wobble signal. The relative position information may be also outputted to the servo unit 540 and the LPP detector 536.

The LPP detector 536 detects an LPP signal component, out of the push-pull signal inputted from the push-pull signal generator 530, and detects pre-format address information expressed by the LPP (Land Pre-Pit), on the basis of the LPP signal. Then, on the basis of the pre-format address information, a recording clock for defining the timing of the recording operation is generated.

The FE detector 537 detects a focus error on the basis of the distribution of signal intensity of the four-division detector, from the sum read signal SRF outputted by the sum generator 520. Then, it outputs a focus error signal to the servo unit 540.

The servo unit 540 is one specific example of the “first controlling device” of the present invention. The servo unit 540 displaces the objective lens of the optical pickup 501 or controls the operation of the spindle motor 502, on the basis of the tracking error signal, the focus error signal, the wobble signal, the LPP signal, or the like, obtained by processing the light receiving result of the optical pickup 501. By this, the servo unit 540 performs various servo processes, such as tracking control, focus control, and spindle control.

The CPU 560 controls the entire information recording/reproducing apparatus 1, by outputting a system command. Typically, software for operating the CPU 560 is stored in an internal or external memory (e.g. ROM).

The memory 570 includes a semiconductor memory, such as a RAM (Random Access Memory) and a flush memory, for example, and is constructed to temporarily record therein the various data necessary for the operation of the information recording/reproducing apparatus 1.

(2) First Operation Example

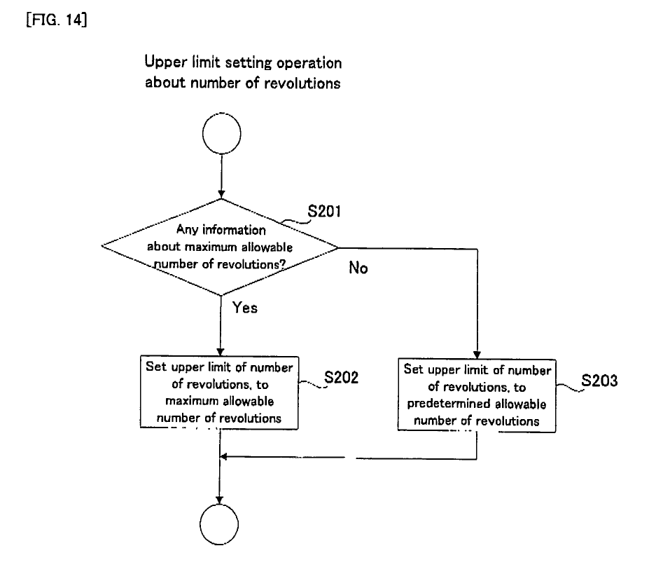

Next, with reference to FIG. 13 and FIG. 14, an explanation will be given for a first operation example out of the recording operation and the reproduction operation of the information recording/reproducing apparatus 1 in the embodiment. FIG. 13 is a flowchart showing a flow of the entire first operation example of the information recording/reproducing apparatus in the embodiment. FIG. 14 is a flowchart showing a flow of the operation of setting the upper limit of the number of revolutions, out of the first operation example of the information recording/reproducing apparatus in the embodiment.

As shown in FIG. 13, firstly, the optical disc 100 is loaded on the information recording/reproducing apparatus 1, and its media type is judged (step S101). Namely, it is judged whether the loaded optical disc 1000 is an optical disc for recording (or for recording the data thereon) or an optical disc for reproduction (or for reproducing the data therefrom) (step S102).

As a result of the judgment, if it is judged that it is the optical disc 100 for recording (the step S102: Yes), then, the optimum recording laser power is calculated by performing the OPC, or checking is performed so as to perform the preferable recording operation in the recording area (particularly, the data recording area 106) on the optical disc 100 (step S103). Then, the upper limit of the number of revolutions of the optical disc 100 during the recording operation is set (step S104). The upper limit setting operation about the number of revolutions will be explained in detail later (refer to FIG. 14).

Then, the data is recorded (step S105). At this time, under the control of the servo unit 540 and the spindle motor 502 or the like, the optical disc 100 is rotationally driven at the number of revolutions which is equal to or less than the upper limit of the number of revolutions set in the step S104. Moreover, if the recording speed is set as described later, the data recording speed is preferably controlled, under the control of the CPU 560, which is one specific example of the “second controlling device” of the present invention, for example.

Then, under the control of the CPU 560, it is judged whether or not the data recording operation is ended (step S106). For example, it may be judged that the data recording operation is ended if all the data to be recorded in this recording operation is recorded onto the optical disc 100, or if an instruction to stop the recording is given from a user of the information recording/reproducing apparatus 1, for example. As a result of the judgment, if it is judged that the data recording operation is not ended (the step S106; No), then, the operational flow returns to the step S105 again, and the data recording operation is continued. On the other hand, if it is judged that the data recording operation is ended (the step S106; Yes), various control information is recorded into the lead-in area 104 or the lead-out area 108, for example, as needed (step S107). Then, the recording operation is ended. At this time, as needed, a finalize process for providing compatibility with a read-only optical disc (e.g. a DVD-ROM, etc.) may be performed, or the optical disc 100 may be ejected from the information recording/reproducing apparatus 1.

On the other hand, as a result of the judgment in the step S102, if it is judged that it is not the optical disc 100 for recording (i.e. it is the optical disc 100 for reproduction) (the step S102; No), then, the upper limit of the number of revolutions of the optical disc 100 during the reproduction operation is set (step S108).

Then, the data is reproduced (step S109). At this time, under the control of the servo unit 540 and the spindle motor 502 or the like, the optical disc 100 is rotationally driven at the number of revolutions which is equal to or less than the upper limit of the number of revolutions set in the step S108. Moreover, if the reproduction speed is set as described later, the data reproduction speed is preferably controlled, under the control of the CPU 560, which is one specific example of the “second controlling device” of the present invention, for example.

Then, under the control of the CPU 560, it is judged whether or not the data reproduction operation is ended (step S110). For example, it may be judged that the data reproduction operation is ended if the reproduction of the data (or title) to be reproduced in this reproduction operation is ended, or if an instruction to stop the reproduction is given from a user of the information recording/reproducing apparatus 1, for example. As a result of the judgment, if it is judged that the data reproduction operation is not ended (the step S110; No), then, the operational flow returns to the step S109 again, and the data reproduction operation is continued. On the other hand, if it is judged that the data reproduction operation is ended (the step S110; Yes), the reproduction operation is ended. At this time, as needed, the optical disc 100 may be ejected from the information recording/reproducing apparatus 1.

Next, a more detailed explanation will be given for the “upper limit setting operation about the number of revolutions” in the step S104 and the step S108 in FIG. 13, with reference to FIG. 14.

As shown in FIG. 14, firstly, it is judged whether or not the allowance information (which is, in this case, the information indicating the maximum allowable number of revolutions) is recorded on the optical disc 100 (step S201). For example, the judgment of whether or not the allowance information is recorded, may be performed by searching a predetermined recording area of the lead-in area 104.

As a result of the judgment, if it is judged that the allowance information is recorded (the step S201: Yes), the upper limit of the number of revolutions of the optical disc 100 in the recording operation or the reproduction operation is set to the maximum allowable number of revolutions indicated by the allowance information (step S202). For example, as shown in the above-mentioned FIG. 3, if the absolute value of the maximum allowable number of revolutions is recorded in the allowance information, the absolute value itself of the maximum allowable number of revolutions may be set as the upper limit of the number of revolutions. As shown in the above-mentioned FIG. 4, if the flag is recorded in the allowance information, the predetermined number of revolutions which is allowed by the flag may be set as the upper limit of the number of revolutions. Alternatively, as shown in the above-mentioned FIG. 5, if the absolute value of the maximum allowable number of revolutions corresponding to the addresses of the optical disc 100 is recorded in the allowance information, a plurality of the upper limits of the number of revolutions may be set in accordance with the address position. Incidentally, in this case, pre-record information, such as the address, is read at the time of “data recording” At the same time, the upper limit of the number of revolutions may be read together, and if there is any change, the upper limit recognized by the information recording/reproducing apparatus may be changed.

On the other hand, if it is judged that the allowance information is not recorded (the step S201: No), the upper limit of the number of revolutions of the optical disc 100 in the recording operation or the reproduction operation is set to the predetermined number of revolutions as default, which is set in advance as the upper limit (step S203). This information indicating the predetermined number of revolutions as the upper limit may be recorded in advance in the memory 570 or the like of the information recording/reproducing apparatus 1, or it may be designated by a user of the information recording/reproducing apparatus 1.

Incidentally, in the above-mentioned flowcharts in FIG. 13 and FIG. 14, the operation of setting the upper limit of the number of revolutions is explained, but the present invention is not limited to this. For example, as shown in the above-mentioned FIG. 6, if the allowance information indicating the range of the allowable number of revolutions is recorded, the range of the number of revolutions may be set in addition to or instead of setting the upper limit of the number of revolutions. Alternatively, as shown in the above-mentioned FIG. 7, if the allowance information indicating the allowable recording speed or the like is recorded, the recording speed or the like may be set. In this case, the number of revolutions (or the upper limit thereof which is defined in relation to the recording speed or the like may be also set together.

Consequently, according to the information recording/reproducing apparatus 1 in the embodiment, it is possible to preferably set the upper limit of the number of revolutions of the optical disc 100, or the like, on the basis of the allowance information. In other words, it is possible to relatively easily identify whether or not to be the optical disc 100 which can be rotationally driven at the number of revolutions more than the rotational speed recommended in the standard. Therefore, there is such a great advantage that it is possible to rotate the optical disc 100 at the number of revolutions more than the rotational speed recommended in the standard in some cases, and it is possible to preferably realize the relatively high recording speed or the like, according to circumstances. Namely, it is possible to receive the same various benefits as those of the information recording medium in the above-mentioned embodiment.

(3) Second Operation Example

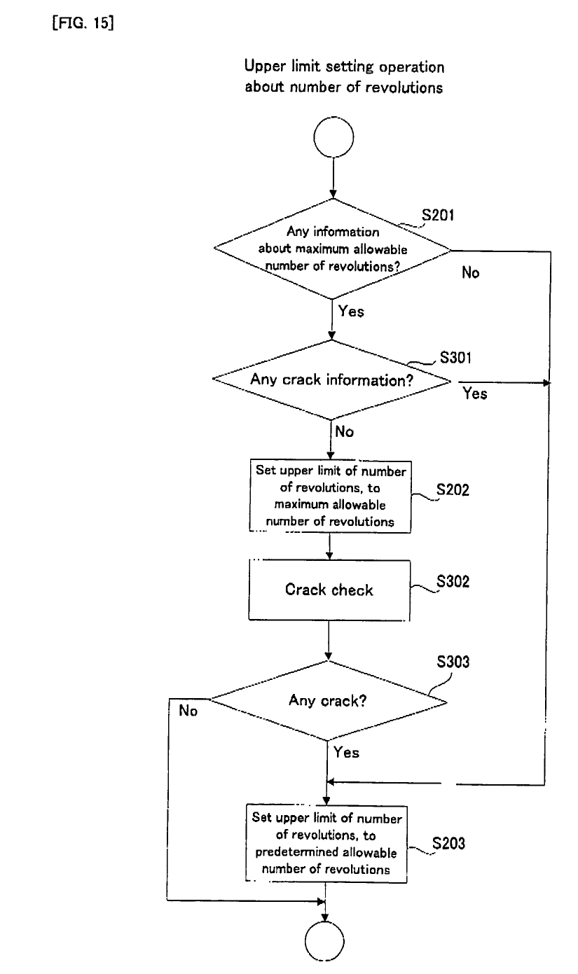

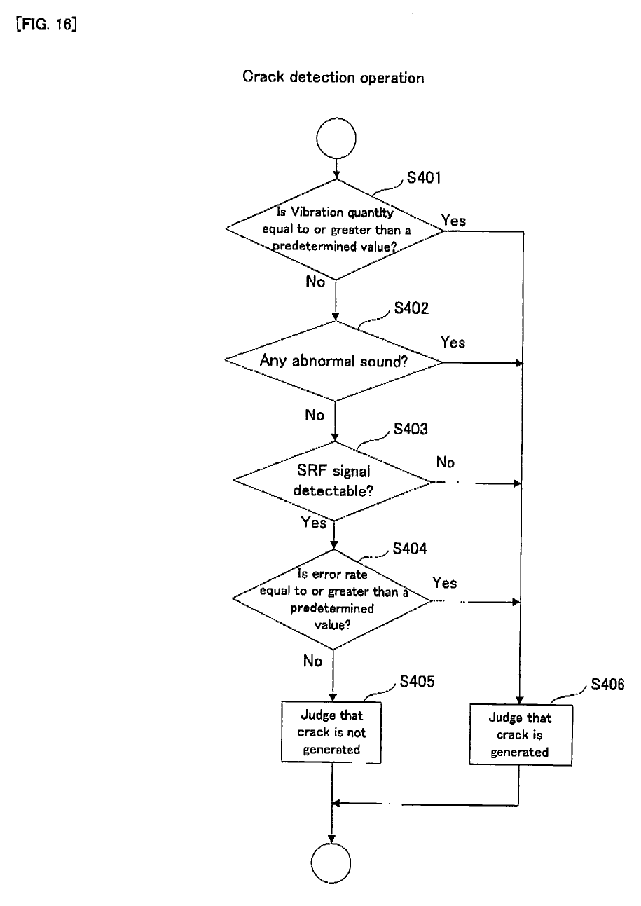

Next, with reference to FIG. 15 and FIG. 16, an explanation will be given for a second operation example of the information recording/reproducing apparatus 1 in the embodiment. FIG. 15 is a flowchart showing a flow of the operation of setting the upper limit of the number of revolutions, out of the second operation example of the information recording/reproducing apparatus in the embodiment. FIG. 16 is a flowchart showing a flow of a crack check operation in the second operation example

Incidentally, the second operation example is common to the first operation example, except for the operation of setting the upper limit of the number of revolutions, so that its explanation is omitted. Therefore, a detailed explanation will be given below for the operation of setting the upper limit of the number of revolutions.

As shown in FIG. 15, firstly, it is judged whether or not the allowance information (which is, in this case, the information indicating the maximum allowable number of revolutions) is recorded on the optical disc 100 (the step S201).

As a result of the judgment in the step S201, if it is judged that the allowance information is recorded (the step S201: Yes), then, it is judged whether or not crack information is recorded on the optical disc 100 (step S301). The crack information indicates information about a detected crack if it is detected that the crack or the like is generated on the optical disc 100 in the recording operation or the reproduction operation before current recording operation or reproduction operation.

As a result of the judgment in the step S301, if it is judged that the crack information is recorded (the step S301: Yes), the upper limit of the number of revolutions of the optical disc 100 in the recording operation or the reproduction operation is set to the predetermined number of revolutions as default, which is set in advance as the upper limit (the step S203). Here, the predetermined number of revolutions as the upper limit may be the same as that in the first operation example. More preferably, the predetermined number of revolutions is the number of revolutions which realizes that the optical disc 100 can be rotationally driven stably even if the crack is generated on the optical disc 100.

On the other hand, as a result of the judgment in the step S301, if it is judged that the crack information is not recorded (the step S301: No), the upper limit of the number of revolutions of the optical disc 100 in the recording operation or the reproduction operation is set to the maximum allowable number of revolutions indicated by the allowance information (the step S202).

Then, the crack of the optical disc 100 is checked (step S302). This crack check operation will be explained in more detail, with reference to FIG. 16.

As shown in FIG. 16, firstly, vibration or oscillating quantity caused by rotating the optical disc 100 is detected by the operation of the vibration/sound sensor 526. Then, under the control of the CPU 560, it is judged whether or not the detected vibration quantity is equal to or greater than a predetermined value (step S401).

As a result of the judgment, if it is judged that the vibration quantity is equal to or greater than the predetermined value (the step S401: Yes), it is judged that the crack is generated on the optical disc 100 (step S406). Incidentally, if it is judged that the crack is generated, the information indicating the crack (e.g. information indicating the presence of the crack) is preferably recorded onto the optical disc 100. On the other hand, if it is judged that the vibration quantity is not equal to nor greater than the predetermined value (the step S401: No), then, a sound caused by rotating the optical disc 100 is detected by the operation of the vibration/sound sensor 526. Then, under the control of the CPU 560, it is judged whether or not an abnormal sound is detected (step S402). The judgment of whether or not the abnormal sound is detected may be performed qualitatively or quantitatively.

As a result of the judgment, if it is judged that the abnormal sound is detected (the step S402: Yes), it is judged that the crack is generated on the optical disc 100 (the step S406). On the other hand, if it is judged that the abnormal sound is not detected (the step S402: No), then, it is judged whether or not the SRF signal can be detected (step S403). With regard to this judgment, it may be judged that the SRF signal can be detected if the number of dropout detected by the operation of the dropout detector 524 is equal to or less than a predetermined number.

As a result of the judgment, if it is judged that the SRF signal cannot be detected (the step S403: No), it is judged that the crack is generated on the optical disc 100 (the step S406). On the other hand, if it is judged that the SRF signal can be detected (the step S403: Yes), then, the error rate of the reproduction data is detected by the operation of the error rate detector 525. Then, under the control of the CPU 560, it is judged whether or not the error rate is equal to or greater than a predetermined value (step S404).

As a result of the judgment, if it is judged that the error rate is equal to or greater than a predetermined value (the step S404: Yes), it is judged that the crack is generated on the optical disc 100 (the step S406). On the other hand, if it is judged that the error rate is not equal to nor greater than a predetermined value (the step S404: No), it is judged that the crack is not generated on the optical disc 100 (step S405).

Incidentally, with regard to the predetermined value, the predetermined number or the judgment of the abnormal sound, which is a reference of the crack detection based on the vibration quantity, the abnormal sound, the dropout number and the error rate described above, it preferably designates a more proper value, numerical value or characteristic or the like, experimentally, experientially, mathematically or theoretically, or individually and specifically by using simulating or the like (e.g. in accordance with the extent of the number of revolutions of the optical disc, various conditions in which the recording operation or the reproduction operation is performed, or the like), in accordance with the characteristics of the crack generated on the optical disc 100.

Incidentally, in the flowchart explained in FIG. 16, it is judged that the crack is generated if one of the vibration quantity, the abnormal sound, the dropout number and the error rate is in a condition capable of indicating the presence of the crack. However, it may be judged that the crack is generated if a combination of two or more out of these information is in the condition capable of indicating the presence of the crack. Moreover, the judgment order related to the vibration quantity, the abnormal sound, the dropout number and the error rate, is not limited to this, but it may be changed, as occasion demands.

Moreover, in the explanation in FIG. 16, the presence or absence of the crack is judged by detecting whether or not there is dropout by using the SRF signal, but in addition to this, the judgment of whether or not the crack is generated on the optical disc 100 may be also performed by measuring quality of a servo signal, which is detected from a focus signal, a tracking signal, the wobble or the LPP.

In FIG. 15 again, as a result of the crack check in the step S302, it is judged whether or not the crack is generated on the optical disc 100 (step S303).

As a result of the judgment in the step S303, if it is judged that the crack is generated (the step S303: Yes), the upper limit of the number of revolutions of the optical disc 100 in the recording operation or the reproduction operation is set to the predetermined number of revolutions as default, which is set in advance (the step S203). The predetermined number of revolutions in this case is also preferably the number of revolutions which realizes that the optical disc 100 can be rotationally driven, stably, even if the crack is generated on the optical disc 100.

On the other hand, as a result of the judgment in the step S303, if it is judged that the crack is not generated (the step S303: No), the recording operation or the reproduction operation is continued (refer to the step S105 and the step S109 in FIG. 13).

On the other hand, as a result of the judgment in the step S201, if it is judged that the allowance information is not recorded (the step S201: No), the upper limit of the number of revolutions of the optical disc 100 in the recording operation or the reproduction operation is set to the predetermined number of revolutions as default, which is set in advance (the step S203).

As described above, in the second operation example, it is possible to set the upper limit of the number of revolutions, in accordance with the presence or absence of the crack on the optical disc 100. Therefore, it is possible to rotationally drive the optical disc 100 while preferably controlling the number of revolutions. At the same time, it is also possible to realize the more preferable recording operation or reproduction operation, with eliminating an adverse influence of the crack on the recording operation or the reproduction operation.

Incidentally, the allowance information may be rewritten due to the presence of the crack or the like. Namely, the allowance information indicating the maximum allowable number of revolutions at which the optical disc 100 can be rotationally driven, stably, even if the crack or the like is generated, for example, may be recorded (or overwritten) onto the optical disc 100. At this time, the number of revolutions which is calculated such that the optical disc 100 can be rotationally driven more stably, by the operation of the CPU 560 which is one specific example of the “determining device” of the present invention, for example, may be set to the maximum allowable number of revolutions or the like. Alternatively, the above-mentioned predetermined number of revolutions as the upper limit may be set to the maximum allowable number of revolutions or the like.

Moreover, regardless of the presence of the crack, in accordance with other factors which can influence the recording operation or the reproduction operation or the like (e.g. the presence of an eccentricity of the optical disc 100, its extent, or the like), the allowance information may be rewritten, as occasion demands. For example, if more than a predetermined amount of eccentricity (e.g. 50 μm or more) is detected, the allowance information may be rewritten. In this case, the maximum number of revolutions (or the number of revolution set as the upper limit) indicated by the allowance information after the rewriting, is preferably the number of revolutions which realizes that the optical disc 100 can be rotationally driven, stably, even if there is more than the predetermined amount of eccentricity on the optical disc 100.

Of course, it is obvious that the allowance information may be rewritten even in the first operation example, as occasion demands.

Moreover, the upper limit setting operation about the number of revolutions, described in the first and second operation examples, is constructed to be performed before the recording operation or the reproduction operation; however, the present invention is not limited to this, and it may be performed in the middle of the recording operation or the reproduction operation, as occasion demands. For example, it may be performed periodically in each predetermined period, or irregularly. Moreover, it may be performed in predetermined timing under the control of the CPU 560, or it may be performed due to an instruction from a user of the information recording/reproducing apparatus 1, which is inputted by using a remote controller and an operation button or the like, for example.

Moreover, except for the information recording medium having a signal recording layer, the present invention can be obviously applied to an information recording medium having a plurality of recording layers, such as two or more layers, for example.

Moreover, in the above-mentioned embodiments, the optical disc 100 is explained as one example of the information recording medium, and the player or recorder related to the optical disc 100 is explained as one example of the information recording apparatus or the information reproducing apparatus. The present invention, however, is not limited to the optical disc and the player or recorder thereof, and can be also applied to various information recording media supporting other high-density recording and high transfer rate and the player or recorder thereof.

The present invention is not limited to the above-described embodiment, and various changes may be made, if desired, without departing from the essence or spirit of the invention which can be read from the claims and the entire specification. An information recording medium, an information recording apparatus, an information recording method, an information reproducing apparatus, an information reproducing method, a computer program for recording control, and a computer program for reproduction control, which involve such changes, are also intended to be within the technical scope of the present invention.

### INDUSTRIAL APPLICABILITY

The information recording medium, the information recording apparatus and method, the information reproducing apparatus and method, and the computer program of the present invention can be applied to a high-density optical disc, such as a DVD, for consumer use or for business use, and moreover, to an information recording apparatus, such as a DVD recorder, for example. Moreover, they can be also applied to an information recording apparatus and the like, which are mounted on or which can be connected to various computer equipment for consumer use or for business use, for example.

1. An information recording medium which is rotationally driven at a rotational speed in a range set in advance,
said information recording medium comprising allowance information recorded on said information recording medium, in accordance with a radial position thereof, the allowance information indicating a range of an allowable rotational speed.

2. The information recording medium according to claim 1, wherein the allowance information is recorded with address information indicating a position of a recording area in which record information is recorded.

3. The information recording medium according to claim 1, wherein said information recording medium is rotationally driven such that the rotational speed is changed in accordance with at least a radial position.

4. The information recording medium according to claim 3, wherein the allowance information indicates a plurality of ranges of the allowable rotational speed in accordance with the radial position.

5. The information recording medium according to claim 3, wherein the allowance information are recorded by at least one, with respect to each of radial positions in each of which the rotational speed is changed.

6. The information recording medium according to claim 1, wherein the allowance information includes flag information indicating whether or not the allowable rotational speed is equal to or greater than a predetermined rotational speed.

7. The information recording medium according to claim 1, wherein the allowance information indicates a range of at least one of an allowable recording speed which can be allowed when record information is recorded, and an allowable reproduction speed which can be allowed when the record information is reproduced, in addition to or instead of indicating the allowable rotational speed.

8. The information recording medium according to claim 7, wherein
at least one of the recording speed and the reproduction speed is changed in accordance with at least the radial position, on said information recording medium, and
the allowance information indicates at least one of the allowable recording speed and the allowable reproduction speed in accordance with the radial position.

9. The information recording medium according to claim 1, wherein the allowance information can be rewritten.

10. An information recording apparatus comprising:
a first recording device for recording record information onto an information recording medium which is rotationally driven at a rotational speed in a range set in advance, said information recording medium comprising allowance information recorded on said information recording medium, in accordance with a radial position thereof, the allowance information indicating a range of an allowable rotational speed;
a rotation driving device for rotationally driving said information recording medium;
a reading device for reading the allowance information; and
a first controlling device for controlling said rotation driving device, on the basis of the read allowance information.

11. The information recording apparatus according to claim 10, wherein said
said information recording apparatus further comprises a detecting device for detecting a crack of said information recording medium, and
said first controlling device controls the rotational speed on the basis of the allowance information if the crack is not detected, and controls the rotational speed so as to be a predetermined rotational speed if the crack is detected.

12. The information recording apparatus according to claim 11, wherein said detecting device detects the crack by detecting at least one of vibration and sound of said information recording medium.

13. The information recording apparatus according to claim 11, wherein said detecting device detects the crack by detecting an error rate of the record information to be recorded onto said information recording medium.

14. The information recording apparatus according to claim 11, wherein said detecting device detects the crack by detecting whether or not the record information to be recorded onto said information recording medium can be reproduced.

15. The information recording apparatus according to claim 10, further comprising a second recording device for recording the allowance information onto said information recording medium.

16. The information recording apparatus according to claim 15, wherein
said information recording apparatus further comprises a determining device for determining a range of the allowable rotational speed in accordance with presence of at least one of a crack of said information recording medium and an eccentricity having an amount more than a predetermined amount, and
said second recording device records at least one of the allowance information indicating the range of the allowable rotational speed determined by said determining device, and flag information indicating at least one of the crack and the eccentricity having the amount more than the predetermined amount.

17. The information recording apparatus according to claim 10, for recording the record information onto said information recording medium, wherein the allowance information indicates a range of at least one of an allowable recording speed which can be allowed when record information is recorded, and an allowable reproduction speed which can be allowed when the record information is reproduced, in addition to or instead of indicating the allowable rotational speed, further comprising:
a second controlling device for controlling the recording speed when said first recording device records the record information.

18. An information recording method in an information recording apparatus for recording record information onto an information recording medium which is rotationally driven at a rotational speed in a range set in advance, said information recording medium comprising allowance information recorded on said information recording medium, in accordance with a radial position thereof, the allowance information indicating a range of an allowable rotational speed,
said information recording method comprising:
a reading process of reading the allowance information; and
a rotation driving process of rotationally driving said information recording medium on the basis of the read allowance information.

19. An information reproducing apparatus comprising:
a reproducing device for reproducing record information recorded on an information recording medium which is rotationally driven at a rotational speed in a range set in advance, said information recording medium comprising allowance information recorded on said information recording medium, in accordance with a radial position thereof, the allowance information indicating a range of an allowable rotational speed;
a rotation driving device for rotationally driving said information recording medium;
a reading device for reading the allowance information; and
a first controlling device for controlling said rotation driving device, on the basis of the read allowance information.

20. The information reproducing apparatus according to claim 19, for reproducing the record information recorded on said information recording medium, wherein the allowance information indicates a range of at least one of an allowable recording speed which can be allowed when record information is recorded, and an allowable reproduction speed which can be allowed when the record information is reproduced, in addition to or instead of indicating the allowable rotational speed, further comprising:
a second controlling device for controlling the reproduction speed when said reproducing device reproduces the record information.

21. An information reproducing method in an information reproducing apparatus for reproducing record information recorded on an information recording medium which is rotationally driven at a rotational speed in a range set in advance, said information recording medium comprising allowance information recorded on said information recording medium, in accordance with a radial position thereof, the allowance information indicating a range of an allowable rotational speed,
said information reproducing method comprising:
a reading process of reading the allowance information; and
a rotation driving process of rotationally driving said information recording medium on the basis of the read allowance information.

22. A computer program product in a computer-readable medium for tangibly embodying a program of instructions executable by a computer provided in an information recording apparatus, said computer program product making the computer function as at least one portion of a first controlling device,
said information recording apparatus comprising:
said first recording device for recording record information onto an information recording medium which is rotationally driven at a rotational speed in a range set in advance, said information recording medium comprising allowance information recorded on said information recording medium, in accordance with a radial position thereof, the allowance information indicating a range of an allowable rotational speed;
said rotation driving device for rotationally driving said information recording medium;
said reading device for reading the allowance information; and
said first controlling device for controlling said rotation driving device, on the basis of the read allowance information.

23. A computer program product in a computer-readable medium for tangibly embodying a program of instructions executable by a computer provided in an information reproducing apparatus, said computer program making the computer function as at least one portion of a reproducing device, a reading device, a rotation driving device, and a first controlling device, said information reproducing apparatus comprising:
said reproducing device for reproducing record information recorded on an information recording medium which is rotationally driven at a rotational speed in a range set in advance, said information recording medium comprising allowance information recorded on said information recording medium, in accordance with a radial position thereof, the allowance information indicating a range of an allowable rotational speed;
said rotation driving device for rotationally driving said information recording medium;
said reading device for reading the allowance information; and
said first controlling device for controlling said rotation driving device, on the basis of the read allowance information.
